(19) United States
(12) Patent Application Publication
(10) Pub. No.: US 2003/0229515 A1
(43) Pub. Date: Dec. 11, 2003

(54) ERROR FREE MEDICAL AND SURGICAL CONSENT

(76) Inventor: Syed Rizvi, Bakersfield, CA (US)

Correspondence Address: JEFFREY FURR, 253 N. MAIN STREET, JOHNSTOWN, OH, 43031, US

(21) Appl. No.: 10/250,098

(22) Filed: Jun. 4, 2003

Related U.S. Application Data
(60) Provisional application No. 60/387,417, filed on Jun. 11, 2002.

(51) Int. Cl. G06F 17/60

(52) U.S. Cl. 705/2

(57) ABSTRACT

The invention is a method of obtaining error free consent for medical and surgical treatment. Software is used to generate an error free consent documentation. The software stores the correct name/names of the facilities, physicians, specialties and procedures and allows the user to print out (or store) the consent by selecting them from the drop down windows.

CROSS REFERENCE TO RELATED APPLICATIONS

This invention claims the priority date of provisional patent 60/387,417 filed on Jun. 11, 2002.

### BACKGROUND OF INVENTION

1. Field of the Invention

The present invention relates to methods for obtaining informed consent to a medical or surgical treatment, particularly for medical procedures such as a hysterectomy, sterilization, a blood transfusion, psychiatric treatment, dental procedures, anesthesia, and the like. More specifically, the present invention relates to interactive simple, fool proof methods for generating a document without errors, i.e. spelling errors, with disclosed information regarding the medical procedure.

2. Background

Virtually every medical procedure performed in the United States, including psychiatric treatment and dental procedures, requires that the patient consent to the procedure. This consent may either be expressed or implied. A competent adult patient can implicitly consent to a procedure by his/her situation or his/her actions. Examples of this type of consent would include certain emergencies and typical physical examinations. Consent to such procedures is implied by the patient. While it is frequently deemed acceptable, it is not the type of consent preferred by the medical community and is to be avoided where possible.

Expressed consent is preferred by the medical community. At present, expressed consent is usually oral or written. The inherent difficulty in proving details with respect to oral consent makes this type of expressed consent less preferable for most health care providers. Using existing techniques, many non-emergency type surgical procedures require the patient to read and sign an “informed consent” form. These procedures, among many others, are deemed to require not merely consent, but informed consent.

The legal requirements can be burdensome to healthcare providers. Not only does complying with such requirements take time, but the constantly changing state of the law and medical vocabulary makes merely remaining current in this developing field a challenge. Names of medical and surgical procedures are complicated or lengthy and are too many to be memorized by healthcare workers and providers. Medical terminology is constantly changing. This causes spelling errors or missing procedures on the consents leading to expensive lawsuits and embarrassing situations in the courtrooms. The present invention is designed to alleviate this imposition on medical personnel by providing a method of generating error free informed consent. The disclosed method improves the ability of generating an informed and personalized consent, and enhances the ability to prove in a court of law that informed consent was properly and professionally established, should it be necessary.

For many years the only device used to indicate possible informed consent was a standard form where the healthcare provider fills the form by writing the required information such as the name of the treatment and the patient's name along with other information as required by local laws. Often the procedures are written incorrectly and when multiple procedures are to be written some procedures are missed due to the number of reasons. Staff finds it very cumbersome and difficult to open the dictionary, look up the procedure and write the proper procedure on the form. Staff in medical facilities just does not have the time to look up or memorize the procedures to be entered on the forms. These poorly written forms combined with the unfavorable outcomes of the treatment fueled by the litigious nature of our society, have contributed to the skyrocketing malpractice insurance fees experienced by many health care providers. These are, naturally, passed on to the patient in the way of higher medical fees charges or the substandard medical care.

These poorly written consents can be very embarrassing to the doctors and nurses when presented in the court of law. The standard consent forms are difficult to modify to accommodate ever-changing needs of healthcare providers.

In order to meet these needs, the present invention utilizes computer software that is not traditionally applied to the informed consent field.

### SUMMARY OF INVENTION

The present invention discloses methods for establishing patient's informed consent in conjunction with medical procedures and treatments, such as used in hospitals, clinics, surgery centers, doctors' offices and other healthcare facilities. The disclosed methods provide a reliable and effective means for generating an informed consent which is error free. This invention serves to establish error free patient's consent to a medical/surgical treatment by providing interactive computer software.

In general terms, the invention involves a unique method for generating error free informed consent. In one instance, the invention takes into account legal and medical requirements for establishing informed consent while providing an interactive process to allow documentation without the errors. Other features of the present invention include selecting the facility name, doctors or the patient's name as well as the physician specialty.

This method can be used with a stand-alone system or incorporated into electronic medical records or any other medium of communication including but not limited to Internet Accordingly, the present invention provides a method which quickly generates patient informed consent with ease. It acts to provide both medical practitioners and patients with a consent that is error free. In addition, accepted medical and legal standards can be used.

It is therefore broadly an object of the present invention to establish a method allowing for error free patient informed consent for a medical, surgical or dental procedure or treatment.

It is another object of the present invention to design a system which is capable of generating patient's informed consent without errors and allowing for modifications as required by ever changing medical and legal needs.

It is another object of the invention to provide a flexible system that can be modified to be used by any specialty for any treatment or a particular specialty for particular procedures and consents.

### BRIEF DESCRIPTION OF DRAWINGS

The drawing, which is incorporated in and constitute a part of this specification, illustrate a preferred embodiment of the invention and, together with the description, serve to explain the principles of the invention.

FIG. 1—Displays a User interacting with the system;

FIG. 2—Displays a Software Screen of the current invention; and

FIG. 3—Displays a Software Screen of the current invention for use by a particular specialty.

### DETAILED DESCRIPTION

The preferred embodiment of the invention is described below.

The present invention discloses methods for establishing patient's informed consent in conjunction with medical procedures and treatments, such as used in hospitals, clinics, surgery centers, doctors' offices and other healthcare facilities. The disclosed methods provide a reliable and effective means for generating an informed consent which is error free. This invention serves to establish error free patient's consent to a medical/surgical treatment by providing interactive computer software.

The current invention uses interactive computer software, protocol and languages that are known to one skilled in the art and therefore not disclosed here in detail.

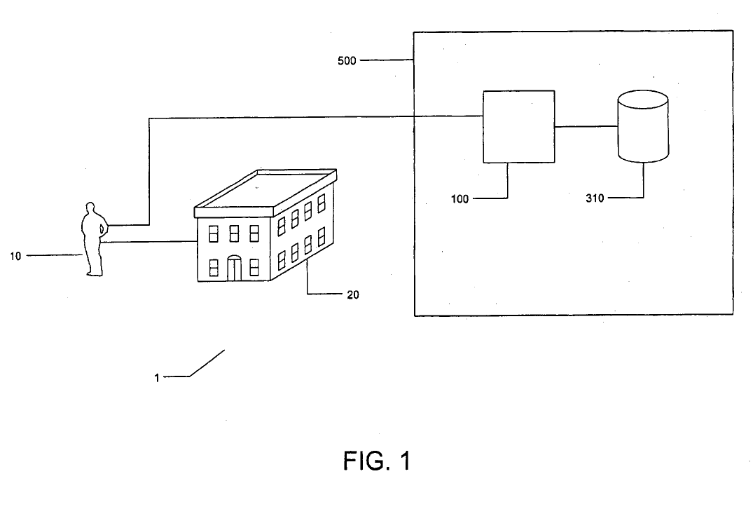

FIG. 1 illustrates a functional diagram of the system 1. A user 10 at a specific location 20, such as a clinic, hospital, doctor's offices or other healthcare facility, connects to a processor 100 that runs the system 1. A user 10 is someone who inputs information into the system 1 or someone who wants to generate a consent form.

A User 10 accesses the system using an informational processing system. A typical system that is used is a personal computer with an operating system such as Windows 95, 98 or ME or Linux. The exact hardware configuration of computer used by a User 10 and the brand of operating system is unimportant to understand this present invention.

Those skilled in the art can conclude that any database language such as D-Base or a compatible language are well known in the art and within the true spirit of this invention and the scope of the claims.

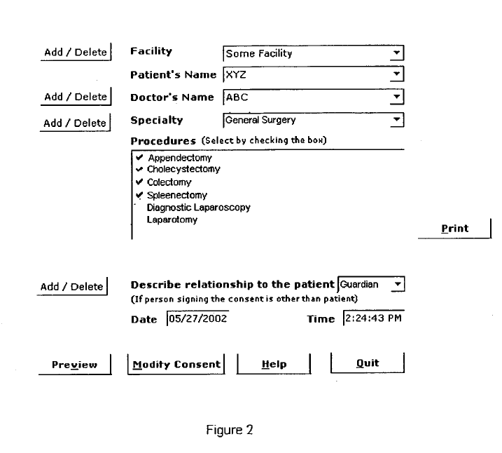

FIG. 2 shows a sample screen of the software version that can be used by any specialty for any treatment. The function of this screen is given below.

A User 10 enters or selects the facility to appear on consent.

An Add/Delete button is used to update the facility name.

A User 10 enters or selects a patient's name. The last ten names (or the predefined number of names) are saved once a document is printed (or stored). The User 10 must select or enter a patient's name before printing (or storing) consent. The User 10 enters or select a doctor's name to appear on consent.

An Add/Delete button is used to update the doctor's names.

A User 10 selects a specialty. Add/Delete button is used to add, delete or modify the specialty and the procedures.

A User 10 selects the procedure by checking the boxes. A User 10 can select up to predefined number of procedures. An Add/Delete button is used to add, delete or modify the procedures. A User 10 must select a procedure before printing (or storing) the consent.

The Print (or save) button is used to print (or store) the consent. The consent is printed on a printing device connected to the system 1.

If person signing the consent is other than the patient, relationship of that person to the patient is selected from “Describe the relationship to the patient” window. An Add/Delete button is used to modify the description.

A new date can be entered by clicking into the date box. Time is highlighted to enter a new time. Preview button is used to preview the consent before printing.

A Modify consent button is used to modify the consent as needed.

A Help button is used for help.

A Quit button is used to close the application.

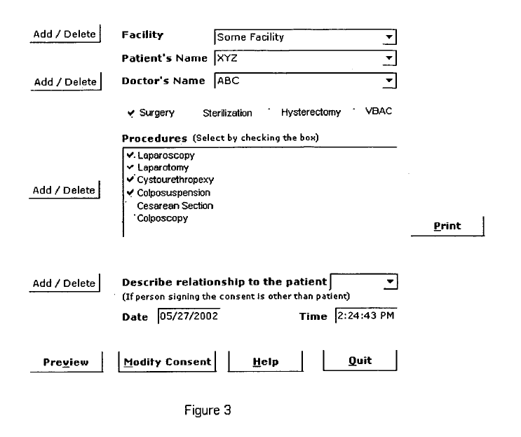

FIG. 3 shows a sample screen of the software version that can be used by a particular specialty for particular procedures and consents.

A User 10 enters or selects the facility to appear on consent. An Add/Delete button is used to update the facility name.

A User 10 enters or selects a patient's name. The last ten (or the predefined number of names) names are saved once a document is printed (or stored).

A User 10 must select or enter a patient's name before printing (or storing) consent.

A User 10 enters or select a doctor's name to appear on consent. An Add/Delete button is used to update the doctor's names.

A User 10 selects the type of consent to print by checking the box. The User 10 can check one or more boxes. One box can be active for the User's 10 convenience when application is started. A User 10 can check or uncheck any box.

A User 10 selects the procedure by checking the boxes. A User 10 can select up to predefined number of procedures. An Add/Delete button is used to add, delete or modify the procedures. A User 10 must select a procedure before printing (or storing) the consent.

The Print (or save) button is used to print (or store) the consent. The consent is printed on a printing device connected to the system 1.

If person signing the consent is other than the patient, relationship of that person to the patient is selected from “Describe the relationship to the patient” window. An Add/Delete button is used to modify the description.

A new date can be entered by clicking into the date box. Time is highlighted to enter a new time.

The Preview button is used to preview the consent before printing.

The Modify consent button is used to modify the consent as needed.

The Help button is used for help.

The Quit button is used to close the application.

The system 1 will allow for the consents to be signed and/or initialed electronically and storing the consents electronically for archival or for later retrieval in a memory storage means 310 which in the preferred embodiment is within the processor 100.

The system 1 can be used with a stand-alone processor 100 or incorporated into electronic medical records or any other medium of communication including but not limited to Internet 500.

With respect to the above description then, it is to be realized that the optimum relationships for the parts of the invention, to include variations in screens, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

It is to be understood that the present invention is not limited to the embodiments described above, but encompasses any and all embodiments within the scope of the claims. It is to be understood that the foregoing description is exemplary and explanatory but are not restrictive of the invention.

What is claimed is:

1. A method of obtaining consent for the medical and surgical treatment using a computer software system which generates a consent form.

2. A method of claim 1 which includes the steps of having the names of the procedures stored by specialty.

3. A method of claim 1 which includes the steps of having names of the physicians and facilities are stored.

4. A method of claim 1 which includes the steps of having the relationship to the patient of the person signing the consent form stored.

5. A method of claim 1 which includes the steps of modifying consents to satisfy changing medical/legal needs in the field of medicine and the needs of healthcare providers.

6. A method of claim 1 which includes the steps of having the consents printed and/or stored digitally.

7. A method of claim 1 which includes the steps of having the consents signed and/or initialed electronically and storing the consents electronically for archival or for later retrieval.

8. A method of claim 1 which includes the steps of having the time and date printed automatically on the consent.

9. A method of claim 1 which includes the steps of storing the procedures sorted by specialty, in a consent, and allowing for the easy storage, entry and selection of the procedure.

10. A method of claim 1 which includes the steps of having a quit button.

11. A method of claim 1 which includes the steps of having a preview functionalilty.

12. A method of claim 1 which includes the steps of having the phyiscian's name as an input.

13. A method of claim 1 which includes the steps of having the facility as an input.

14. A method of claim 1 which includes the steps of having a help function.

15. A method of claim 1 which includes the steps of having the time and date printed automatically on the consent.

16. A method of claim 1 which includes the steps of using drop down windows.

17. A method of claim 1 which includes the steps of having an add/delete/modify function.

18. A method of obtaining consent for the medical and surgical treatment using a computer software system which generates a consent form, having the names of the procedures stored by specialty, having names of the physicians and facilities stored, having the relationship to the patient of the person signing the consent form stored, having the consents printed and/or stored digitally, storing the consents electronically for archival or for later retrieval, and having the time and date printed automatically on the consent.

19. A method of claim 18 which includes the steps of modifying consents to satisfy changing medical/legal needs in the field of medicine and the needs of healthcare providers.

20. A method of claim 18 which includes the steps of using drop down windows.
